(19) United States
(12) Patent Application Publication
(10) Pub. No.: US 2003/0182906 A1
(43) Pub. Date: Oct. 2, 2003

(54) Automatic air filter cleaner

(76) Inventors: Sukree Chullanandana, Nutley, NJ (US); Surat Sangpleng, Nutley, NJ (US)

Correspondence Address: Sukree Chullanandana, 29C Yale Street, Nutley, NJ, 07110, US

(21) Appl. No.: 10/223,728

(22) Filed: Aug. 20, 2002

(30) Foreign Application Priority Data
Mar. 27, 2002 (TH) 073148

(51) Int. Cl. B01D 46/00

(52) U.S. Cl. 55/283; 55/302; 55/385.1

(57) ABSTRACT

The working process of the automatic air filter cleaner can be broken down to 3 specific operating functions. These functions are the controlling system, cleaning system, and the dust collecting system.

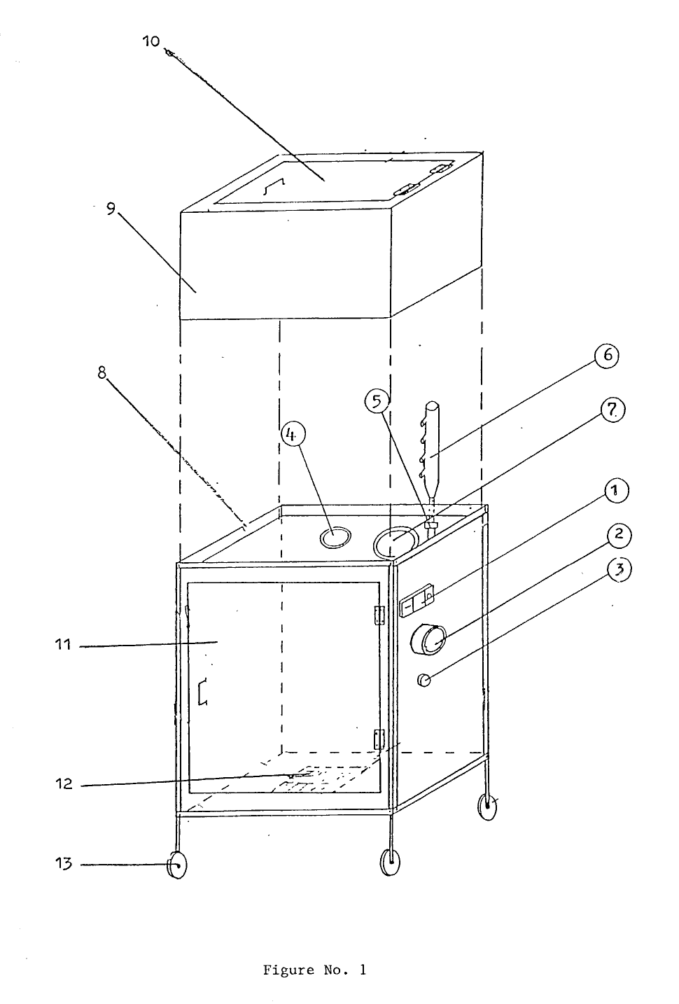

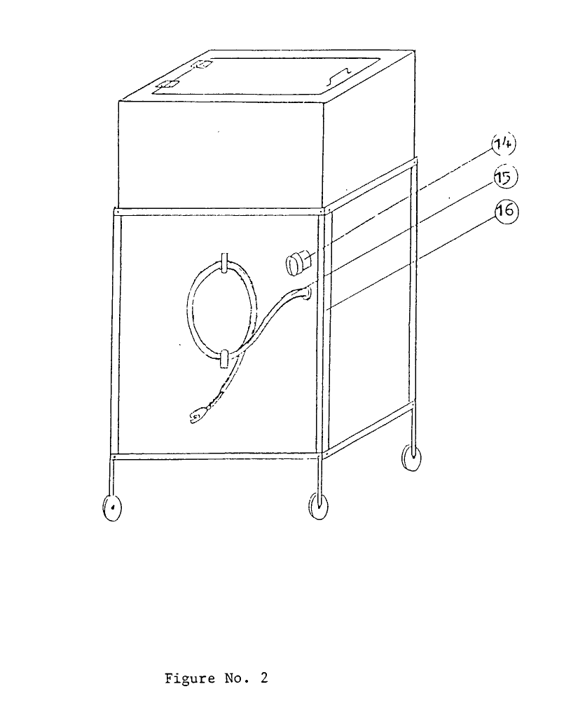

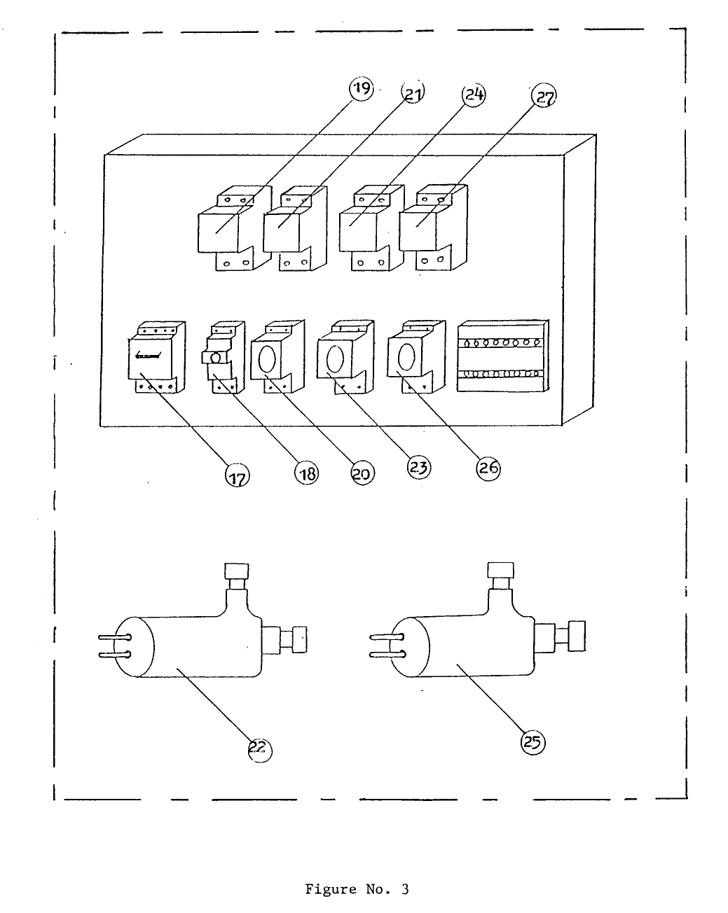

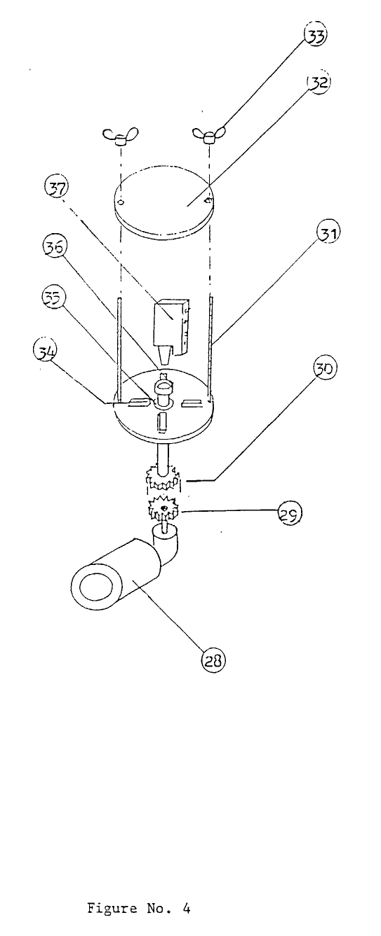

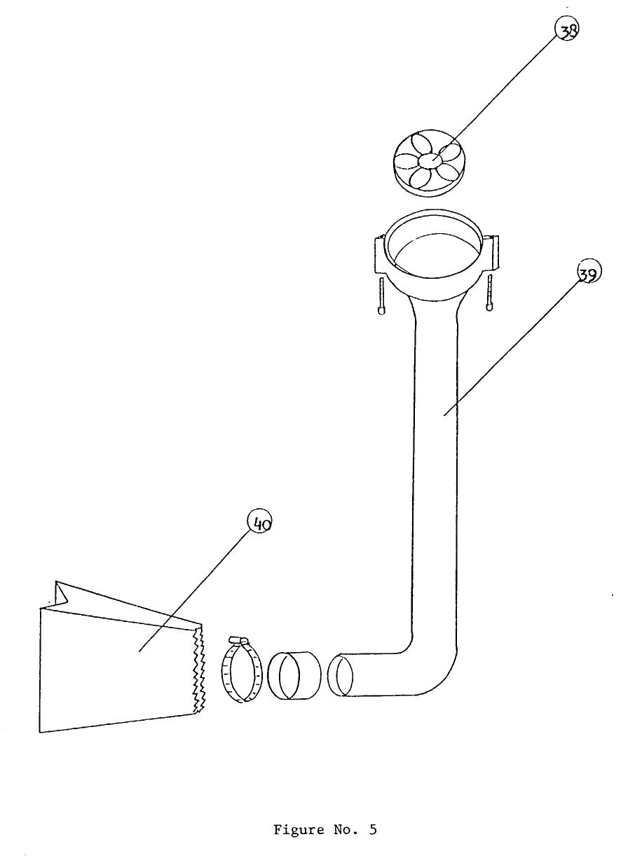

The benefits and advantages of using the automatic air filter cleaner to the public and the environment is the elimination of air pollution (dust). However, to the users and their colleagues, they must not touch the dust coming out of the air cleaner because it can affect our complexion or breathing system commonly derived from climatic sensitiveness or allergic reactions. Moreover the air filter cleaner can create the pleasant atmosphere of working without noise and the presence of dust. Neighboring places are always cleaned and require no excessive and repetitive cleaning after the operation.

The system leaves lots of time left for checking or preparing other automobile programs while the air filter cleaner operates because it requires little control or care. The operation is very easy because you just install the air filter onto the rotating air filter plate and then press the switch to start cleaning and the machine will complete the operation process automatically.

### THE TECHNOLOGY INVOLVED WITH THE INVENTION

It is the engineering involved with automatic air filter cleaning.

### THE BACKGROUND OF ART OF TECHNOLOGY INVOLVED

Presently, the cleaning of automobile air filters involve the use of direct dust blowing heads. This traditional way causes dust particles from the air filter to fly uncontrollably throughout the air. These dust particles can take hours to settle. Thus, causing the work environment to be dirty and unhealthy for anyone within the work place. Once settled, the dust particles are very difficult to clean. The people involved with cleaning the air filter and their co-workers face the dust problem aforementioned an this may cause their body to develop a rash that affects the complexion and breathing system, particularly for those who (are allergic) get sick by climatic sensitiveness.

The objective of this invention is to solve the problem mentioned by designing equipment for air filter cleaning within the containment room to stop the spread of dust. The equipment comprises of a dust exhaust system that exhausts or sucks the dust particles from the containment room to a dust collection sack. When the air filter is installed in the air filter cleaner it becomes an automatic operation. One just presses the operating knob and the air filter cleaner will automatically complete the operation.

The primary function or the purpose of the engine air filter is to clean the enormous amount of air used by the engine. It must filter out airborne dust and dirt that would otherwise enter the engine and course premature wear.

The air filter now becomes an important part of the performance package. The Automatic Air Filter Cleaner (Machine) will need to use to complete the course. It will provide filtration without sacrificing airflow for a longer period of time—that is performance is value.

The Automatic Air Filter Cleaner (Machine)—The New Revolution Device

The objective of the machine is by designing equipment for air filter cleaning within the containment room to stop the spread of dust Some of the automobile, mobile air filters will be replaced instead of cleaning, for one of the reason because of there is not a proper device to do so. The air filters can renewable, cleanable and reusable. They are used for the pick up trucks, the trucks and the heavy-duty equipments.

Cleaning System The Proper And Correct Method Used.

There are two parts of the system.

First, the inner dust blowing head-by using a newmatic type. When the operation starts, it will automatically move the media interval, goes up and down from the bottom to the top blowing the dust particles out off the filter media, which the air filter is installed onto the rotating air filter plate by slowly turning. This is a very important course application. Only an inside-out cleaning is a proper and correct cleaning method used.

Second, the outer dust blowing head is used for blowing the spread of dust in the dust containment room but not to clean the filter itself. This helps and makes it easier for the dust exhausting system.

The New Revolution Device Is Good For the Economic Performance And The Environment.

Pleated paper media air filters can renewable, cleanable and reusable for the lifetime of cars and trucks, until they are considered no longer serviceable. Renewable element is probably the single easiest and most cost effective performance—up grade you can make to your vehicle.

There are number of reasons why cleaning air filters are environmentally sensitive.

First, they are from renewable sources and which deplete the earth of their elements.

Second, they are cleanable and reusable, do not add to the already ever growing—waste of the planet. It does not, in other words, find the way into our landfills each year unlike the filters that have to be discarded every 12,000 to 15,000 miles (21,000 to 27,000 km.) or on annual basis.

If you consider for a moment, the total number of registered vehicles in the worldwide the air filters that will litter our environment. In the United States alone—which is well over a quarter of a billion—that is more than 250,000,000 filters that will litter our environment! You can make an immediate difference today simply by switching to clean the air filter that gets re-used again and again.

Understand that all of the above benefits, renewable, cleanable and reusable air filters, it is no wonder the users feel they are helping preserve the environment!

Some Important Tips About Air Filters

Service Intervals.

Cleaning is a high-performance air filter, both in—term of airflow and filtration. However, the service intervals can vary widely depending on the severity of the driving conditions, such as dirt and debris or dust and mud, the restriction value increase. If the restriction is allowed to grow higher the filter media might become so restricted that element could distort allowing dirty air to bypass the filter and enter the engine. Conversely, proper cleaning air filter with the right tool can prevent the courses and increase its serviceable life expectancy.

Service Life

The air filter service life had no relationship to mileage or even time. It is entirely depended on the amount of contaminate of the air coming through, some air filter looks dirty but it is actually good for a thousand more miles, the other filter looks clean but it is almost 90% plugged. Remember, the air filter can renewable, cleanable and reusable, until it is considered no longer serviceable.

A Short Explanation:

FIG. No. 1 Showing equipment on structure (front side)

FIG. No. 2 Showing equipment on structure (back side)

FIG. No. 3 Showing an automatic controlling equipment

FIG. No. 4 Showing rotating and holding equipment

FIG. No. 5 Showing the dust collecting equipment

FIGS. No. 6 & 7 Showing the types of the air filter that can be cleaned

Revealing the perfect invention:

FIG. No. 1: The structure is made of right (wrought) iron in square types comprising of plywood on three sides: the backside and the two in the left and right sides. The on-off switch is installed on the left side to operate the machine (1). The adjusting knob for rotating the air cleaner (2). The electric lamp showing systematic functioning (3). The iron sheet with a hole used as the central point rotating plate and for the air tube to go through (4). The joining of outside dust blowing head (5) to connect the air tube with outsider dust blowing head (6). The dust-exhausting channel (7). The side structure is designed to be higher than the iron sheet (8) to receive the dust cover, which is made of transparent plastics (9). The top opening/closing cover used for fitting the air filter (10). The front closing/opening door is made of transparent plastics (11). The sieve at the bottom side ventilates air while exhausting the dust (12). Fitting wheels provide convenience in moving (13).

FIG. No. 2: At the backside of the structure, the air connection joint is installed to transport air into the system (14). Electrical wires can be kept neatly on the backside of the structure (15). Using the edge enameled with aluminum to cover the four corners of the sides (16).

FIG. No. 3: The automatic controlling set is comprised of a breaker (17) and a fuse set (18) to send the power to relay which ultimately controls the rotation of the air filter plate (19) before the blowing process starts. Once can set timing of rotation for the air filter plate by adjusting the controlling timer of rotation for the air filter cleaning plate before blowing (20). After that the time controlled relay for inner dust blowing (21) will order the controlling valve for inner dust blowing (22) to distribute the air to inner dust blowing heads that are able to control the time by adjusting and installing the controlling timer for inner dust blowing (23). Then the outer controlling relay (24) will order the inner controlling valve to stop operating and order the outer controlling valve (25) to distribute the air to the outer dust blowing head. One can control the period of time by adjusting the outer time controlling timer (26). When the operation ends, the relay will cut off the operation (27) and the power current feeding into it will be cut off automatically, stopping the operation.

FIG. No. 4: The set of rotating air filter cleaning plate is comprised of an electrical motor (28), which gives its power (29) by turning the gears (30). On the rotating air filter cleaning plate there are two poles (31). Moreover, there is a round plate made of plastic with two holes to be put into the poles (32) to hold the air filter with the air filter cleaning plate. The butterfly knobs are used to assist the round plate by holding the air filter with the air filter cleaning plate (33). There are four supporting pillows on the air filter cleaning plate for air circulation while cleaning (34). The hole at the central rotating point of the air filter cleaning plate (35) is used for the air tube to pass through and connect it to the inner dust blowing head (37).

FIG. No. 5: The dust collecting set is comprised of an exhausting fan (38) which function to exhaust the dust in the cleaning room through the tube set of PVC (39) into the dust collecting sack (40).

FIGS. No. 6 & 7: Showing the types of the air filter that can be cleaned

### How to Make the Best Invention

It is made as mentioned in the theme of revealing the perfect invention.

1. The automatic air filter cleaner is comprised of an automatic operation controlling set, a cleaning room, a rotating air filter cleaning plate, and equipment for dust exhausting and collecting.

2. From item no. 1. It is an automatic operation controlling set, which was explained in the revealing of the perfect invention section.

3. From item no. 2. The automatic operation controlling set is comprised of one breaker, one fuse, four relays, three timers and two valves.

4. From item no. 1. The cleaning room where the dust is contained in. There is a dust exhausting equipment with a dust-exhausting fan to suck the dust from this room to the dust collecting sack.

5. The operation begins when the air filter is installed in the air filter cleaner, then one presses the operation knob causing the air filter cleaner to automatically complete its operation.

6. The operation of the air filter cleaner. When pressing on the operation knob, the motor will move the air filter cleaning plate around. The inner air-controlling valve will send the jet of air to the inner dust blowing head. The inner dust blowing head will automatically move inside the media interval, goes up and down from the bottom to the top blowing the dust particles out off the filter media, which the air filter is installed onto the rotating air filter plate by slowly turning. This is very important course application. Only an inside—out cleaning is a proper and correct cleaning method used. Afterwards, the outer air controlling valve will send the jet of air to the outer dust blowing head for an automatic cleaning operation. The outer dust blowing head is used to blow the spread of dust in the dust containment room. This helps and makes it easier for the dust exhausting system, not to clean the filter itself.

7. From item no. 4. The operation room is comprised of a dust cover that is able to open and close, a rotating air filter cleaning plate, the holding equipment to hold the air filter with the rotating air filter cleaning plate in place, the inner and outer dust blowing heads and the dust exhausting equipment.

8. From item no. 6. When the motor makes the rotating air filter plate move, the dust-exhausting fan will operate. When the operation is completed, the motor will stop and the dust-exhausting fan will stop too.
